(19) United States
(12) Patent Application Publication
(10) Pub. No.: US 2009/0108542 A1
(43) Pub. Date: Apr. 30, 2009

(54) Seal Assembly for Relieving Pressure

(75) Inventor: Holger Jordan, Neuhausen (DE)

Correspondence Address: KOHLER SCHMID MOEBUS, RUPPMANNSTRASSE 27, D-70565 STUTTGART, DE

(73) Assignee: SEMICONDUCTOR ENERGY LABORATORY CO., LTD, KANAGAWA-KEN (JP)

(21) Appl. No.: 12/227,211

(22) PCT Filed: Apr. 21, 2007
(86) PCT No.: PCT/DE2007/000706

§ 371 Date: Nov. 12, 2008

(30) Foreign Application Priority Data
May 16, 2006 (DE) 10-2006-023-157.0

(51) Int. Cl. F16J 15/56

(52) U.S. Cl. 277/589

(57) ABSTRACT

In a seal assembly (1) for sealing a high-pressure side (H) in relation to a low-pressure side (N) with at least one relief bore or relief channel (6) for pressure relief, a sealing ring (2) and at least one pre-stressing element (3) are arranged in a groove space (5) between two machine parts (4a, 4b) that can be displaced towards one another in a translatory manner, in such a way that the pre-stressing element (3) tensions the sealing ring (2) with both a radial force component (210) and an axial force component (220), and the sealing ring (2) lies against the second machine part (4b) and the groove flank (51) on the low-pressure side by means of defined contact surfaces (20, 22).

The invention concerns a sealing arrangement between two machine parts that can be moved in a translatory fashion with respect to each other, for sealing a high-pressure side with respect to a low-pressure side, consisting of a viscoplastic sealing ring and at least one rubber-elastic pretensioning element, wherein the sealing ring comprises one or several relief bore(s) or relief channel(s) having openings on the low-pressure side, which face the low-pressure side in the pressurized state of the sealing arrangement, and also openings on the high-pressure side.

In sealing arrangements between machine parts that can be moved with respect to each other, the medium pressure in the spaces between the individual sealing elements, e.g. a primary and a secondary seal, may build up during operation, i.e. during a translatory motion of the two machine parts with respect to each other. This is caused by unfavorable speed ratios of the machine parts, e.g. of a piston rod relative to the installation space. An increased pressure e.g. on the low-pressure side can damage the machine parts or even destroy them, and thereby cause failure of the entire sealing arrangement.

A pressure relief sealing arrangement comprises relief bores or channels, which are used for pressure relief comparable to a check valve. A sealing arrangement of this type is disclosed e.g. in DE 101 17 662 C1. In a basic pressure position, in which the sealing arrangement seals a high-pressure side with respect to a low-pressure side, the relief bores or channels provided on a sealing ring are closed, and in a pressure relief position, in other words, in the inverted pressure position, they are released, i.e. opened, such that a pressure that prevails in a space on the low-pressure side can be discharged towards the high-pressure side when an overpressure has been reached. Conventional pressure relief sealing arrangements do not guarantee, for all operating states, that the relief bores or channels are opened only when the pressure relief position has been reached for arbitrary pressure ratios in the system and/or speed ratios of the machine parts. Premature opening or release of the relief bores or channels negates the pressure relief function of the sealing arrangement and a pressurized medium can flow from the high-pressure side to the low-pressure side.

It is the underlying purpose of the invention to ensure that the relief bores or relief channels of a pressure relief sealing arrangement open exclusively in a pressure relief position.

This object is achieved in accordance with the invention by a sealing arrangement between two machine parts that can be moved in a translatory fashion, for sealing a high-pressure side with respect to a low-pressure side, consisting of a viscoplastic sealing ring and at least one rubber-elastic pretensioning element, wherein one or several relief bore(s) or relief channel(s) is/are provided in the sealing ring, which have openings on the low-pressure side, which face the low pressure side in the pressurized state of the sealing arrangement, and also openings on the high-pressure side, wherein, when the sealing arrangement is installed in a groove space, the opening(s) on the low-pressure side is/are closed by a groove flank on the low-pressure side of the groove space, which is associated with the low-pressure side in the pressurized state, or by the at least one pretensioning element, or limited by the groove flank on the low-pressure side, a groove bottom of the groove space and the pretensioning element, and in the installed pressure-free state, the sealing ring abuts the groove flank on the low pressure side with an axially oriented force component.

The force component with axial orientation, i.e. parallel to the direction of the translatory motion of the two machine parts, urges or presses the sealing ring towards the groove flank on the low pressure side to thereby prevent connection between the low-pressure side or a space following the sealing ring on the low-pressure side, and the opening on the low-pressure side of the relief bore or the relief channel. The connection between the space on the low-pressure side and the opening on the low-pressure side is permitted only when there is a corresponding counter force to the axial force component, i.e. in the pressure relief position.

In a preferred embodiment of the inventive sealing arrangement, the sealing ring comprises one or several partial surfaces that are oriented at an inclination with respect to the groove bottom on its outer surface facing the groove bottom.

This embodiment is advantageous in that the axial force component is realized by the geometrical design of the outer surface of the sealing ring. The pretensioning element that tensions the sealing ring abuts an inclined partial surface of the sealing ring, thereby urging or pretensioning the sealing ring in an axial direction towards the low-pressure side. The axial force component can be adjusted, i.e. increased or reduced, in accordance with the requirements through suitable profiles of the sealing ring and/or the pretensioning element, in particular, through selection of the inclination of the contact surface between the sealing ring and the pretensioning element.

In a further preferred embodiment, the pretensioning element abuts the outer surface and at least one high-pressure sided side flank of the sealing ring, which is formed on the high-pressure side.

The pretensioning element is partially positioned between the side flank of the sealing ring on the high-pressure side and the groove flank on the high-pressure side. The axial overdimension of the pretensioning element with respect to the groove or the groove space generates an axial pressure on the sealing ring and thereby the axial force component for abutment of the sealing ring on the groove flank on the low-pressure side. The pretensioning element is preferably designed as a molded part.

The sealing arrangement is further characterized by two pretensioning elements.

Each of the two pretensioning elements that preferably abut a partial surface of the sealing ring, which is oriented parallel to the groove bottom, and a partial surface thereof, which is oriented at an inclination with respect to the groove bottom, generates one of the radial component and the axial component of the force transmitted to the sealing ring by the pretensioning elements. This is advantageous in that standardized pretensioning elements can be used for the inventive sealing arrangement, e.g. O-rings, 4-sided rings, quad rings® (registered trademark of the company Quadion Corporation, Minneapolis, US), which minimizes, in particular, the production costs of the sealing arrangement.

In another preferred embodiment of the inventive sealing arrangement, in the installed state, the sealing ring abuts the groove flank on the low-pressure side and a groove flank of the groove space on the high-pressure side.

In this embodiment, the axial force component is provided by the sealing ring itself, which abuts both sides of the groove flank of the groove space on the low-pressure side and the high-pressure side, and is compressed or squeezed in this position. Viewed in the axial direction, the sealing ring is overdimensioned with respect to the groove space.

The sealing ring also has an additional sealing edge on a side flank on the low-pressure side.

The design of the additional sealing edge prevents pressure medium, e.g. hydraulic liquid or lubricating oil, from entering into a partial space of the groove space, in which the relief bores or channels terminate on the low-pressure side.

The first machine part is moreover preferably a cylinder, and the second machine part is a piston rod of a piston guided in the cylinder.

The inventive pressure relief sealing arrangement is particularly suited for use in a hydraulic system.

A pressure-free state as defined in accordance with the invention is a state in which the sealing arrangement is installed in a groove space and the pressurized medium does not yet load the sealing arrangement. A pressurized state as defined in accordance with the invention is a state in which the sealing arrangement that is installed in the groove space is loaded with the pressurized medium.

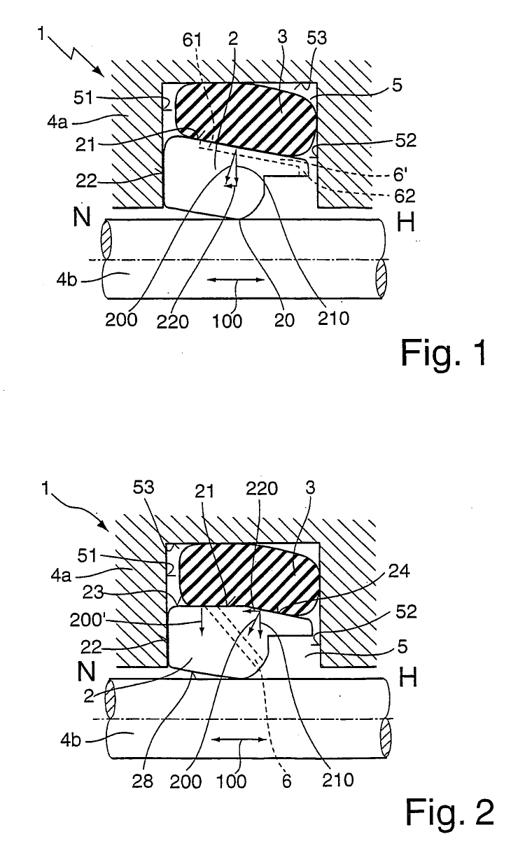

Further advantages and features of the invention can be extracted from the description and the figures of the drawing. The inventive sealing arrangement is shown in embodiments in FIGS. 1 through 8. The features illustrated in the figures are only schematic and are not to be taken to scale.

In the drawing:

FIGS. 1 through 8 each show one exemplary sealing arrangement between two machine parts which can be moved in a translatory fashion with respect to each other.

FIG. 1 shows a section through a sealing arrangement 1, in which a sealing ring 2 and a pretensioning element 3 are disposed between a first machine part 4a and a second machine part 4b. The second machine part 4b, in the present case a piston, is guided along a translatory direction 100 relative to the first machine part 4a that is designed as a cylinder, and can be moved in the translatory direction 100. The two machine parts 4a and 4b define a groove space 5 having a box-shaped cross-section, with a groove flank 51 on the low-pressure side, an opposite groove flank 52 on the high-pressure side, and a groove bottom 53. For sealing a low pressure side N and a high-pressure side H, the sealing ring 2 and the pretensioning element 3 are inserted, pressed, deformed and tensioned in the groove space 5 in such a fashion that the pretensioning element 3 exerts a force on the sealing ring 2 along direction 200. The overall force 200 has a radial force component 210 that causes tight abutment of the sealing ring 2 on the second machine part 4b via a sealing edge 20, and an axial force component 220 that causes tight abutment of the sealing ring 2 on the groove flank 51 on the low-pressure side. The outer surface 21 of the sealing ring 2 is slanted with respect to the groove bottom 53. This slant generates the axial force component 220. Due to this axial force component 220 that extends parallel to the translatory direction 100, the front side flank 22 of the sealing ring 2, which is formed as a front side, abuts the groove flank 51 on the low-pressure side.

This abutment prevents connection between the low-pressure side N or a space bordering the sealing arrangement 1 at that location, and a relief channel 6′ provided in the sealing ring 2. This connection is released only upon exertion of a corresponding axial counter force and release of contact between the side flank 22 on the high-pressure side and the groove flank 51 on the low-pressure side. An opening 61 of the relief bore 6 on the low-pressure side is closed by the pretensioning element 3 in the illustrated installed state both in the pressure-less state and in a basic pressure position, and is opened only when a pressure relief position has been reached through corresponding displacement and/or deformation of the pretensioning element 3. An opening 62 of the relief channel 6′ on the high-pressure side is provided on a side surface of the sealing ring 2 facing the second machine part 4b, which is open in any pressure position.

FIG. 2 shows a further embodiment of the sealing arrangement 1. The sealing ring 2 has a relief bore 6 that extends from the outer surface 21 to a side surface facing the second machine part 4b, and a first 23 and a second 24 partial surface on its outer surface 21. The first partial surface 23 is straight, in other words parallel to the groove bottom 53 of the groove space 5, and the second partial surface 24 that borders the first partial surface 23 towards the high-pressure side H is inclined with respect to the groove bottom 53. The sealing ring 2 and the pretensioning element 3 are clamped in the groove space 5 between the first and the second machine part 4a and 4b, thereby producing a tensioning force that the pretensioning element 3 exerts on the sealing ring 2. In the illustrated embodiment, the overall tensioning force consists of a first partial force 200′ that acts on the first partial surface 23, and a second partial force 200 that acts on the second partial surface 24. The axial force component 220 that is required for abutment of the sealing ring 2 on the groove flank 51 on the low-pressure side is exclusively provided by the second force 200. An inner surface facing the second machine part 4b may be slanted, as illustrated, but may also have a symmetrical profile.

FIG. 3 shows a further embodiment of the sealing arrangement 1. A pretensioning element 3 that is designed as a quad rings is disposed in the groove space 5 together with the sealing ring 2 and exerts a force on the latter. The pretensioning element 3 abuts both the groove flank 51 on the low-pressure side and the groove flank 52 on the high-pressure side. A force 200 of the pretensioning element 3 that abuts a slanted second partial surface 24 of the sealing ring 2 produces the axial force component 220. The opening 61 of the relief bore 6 on the low-pressure side is closed by the pretensioning element 3. After an interruption, the relief bore 6 continues to extend towards the high-pressure side H in the form of a terminating bore 6″, at the end of which the opening 62 on the high-pressure side is provided.

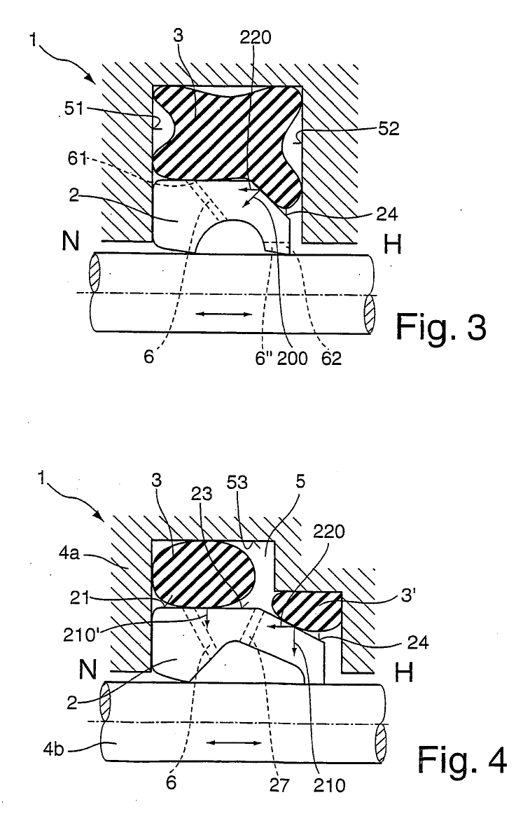

FIG. 4 shows a sealing arrangement 1 of a sealing ring 2, a pretensioning element 3 and a further pretensioning element 3′. The groove space 5 between the two machine parts 4a and 4b has a two-step groove bottom 53. The pretensioning element 3 that closes the relief bore 6 that is formed in the sealing ring 2, is supported on a flat first partial surface 23 of the sealing ring 2, which extends parallel to the groove bottom 53, and clamps it in the radial direction 210′. The further pretensioning element 3′ abuts an inclined slanted second partial surface 24 of the outer surface 21 and exerts a force on the sealing ring 2, which acts in a radial direction 210 and in an axial direction 220. In this embodiment, the inventive sealing arrangement 1 is realized with a sealing ring 2 having a particular profile and with two pretensioning elements 3 and 3′ selected as standard elements. The sealing ring 2 has an additional bore 27 via which the pretensioning element 3 can be activated.

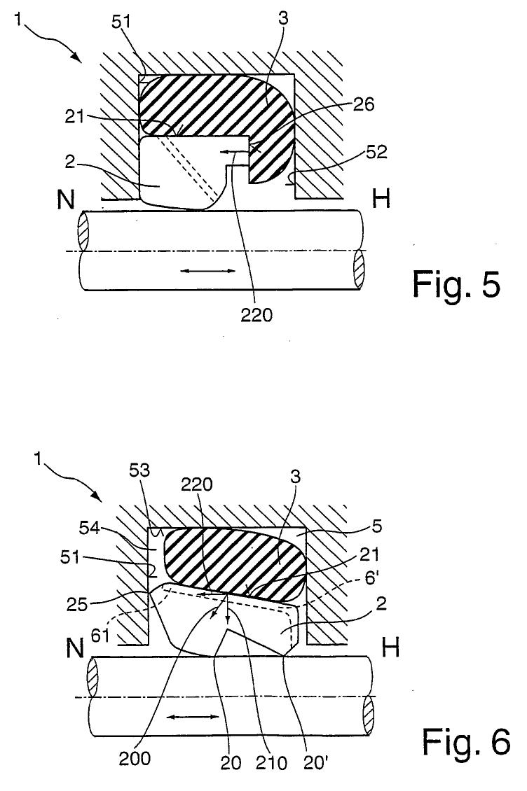

FIG. 5 shows a further embodiment of the sealing arrangement 1. The pretensioning element 3 that tensions the sealing ring 2 in a radial direction and exerts a force on the sealing ring with an axial force component 220, is designed as a molded part and abuts the outer surface 21 and a rear side flank 26 of the sealing ring 2, which faces the high-pressure side H. The pretensioning element 3 that is clamped between the two groove flanks 51 and 52 abuts the rear side flank 26 of the sealing ring 2, thereby adjusting the axial force component 220 and ensuring abutment of the sealing ring 2 on the groove flank 51 on the low-pressure side.

The embodiment of the sealing arrangement 1 shown in FIG. 6 is characterized by a relief channel 6′ which extends along the outer surface 21 and the rear side flank 26 of the sealing ring 2 and is not closed by the pretensioning element 3 in the illustrated pressure-free state, but terminates in a partial space 54 of the groove space 5 on the low-pressure side. The partial space 54 is limited by the groove flank 51 on the low-pressure side, the groove bottom 53 and the pretensioning element 3. The sealing ring 2 abuts the groove flank 51 on the low-pressure side via an additional sealing edge 52, limits the partial space 54 by this additional sealing edge 25, and prevents connection between the partial space 54 as well as the relief bore 6 that terminates therein, and a space that joins the low-pressure side N or the low-pressure side N. The sealing ring 2 seals in an axial direction 220 via the additional sealing edge 25 and in a radial direction 210 via the sealing edges 20 and 20′ by means of the force 200 exerted on the sealing ring by the pretensioning element 3 that abuts its outer surface 21 that is oriented at an inclination.

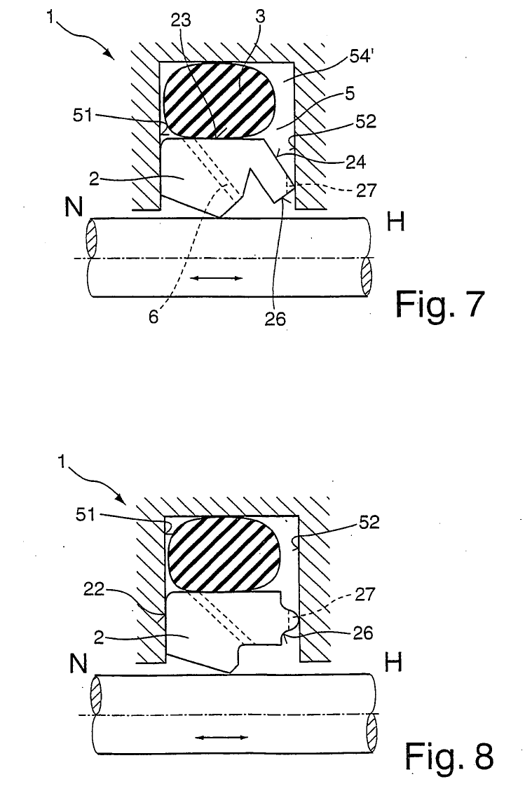

FIG. 7 shows an embodiment of the sealing arrangement 1, in which the force required for axial abutment is provided through the sealing ring 2 itself or through its position in the groove space 5. The sealing ring 2 abuts the groove flank 51 on the low-pressure side and the groove flank 52 on the high-pressure side. In other words, it is clamped between the two groove flanks 51 and 52. An additional groove 27 is provided on the rear side flank 26, through which the high-pressure side H is connected to a further partial space 54′ located behind the pretensioning element 3. The sealing ring 2, shown in cross-section, has further, preferably equally spaced, additional grooves along its periphery. The sealing ring 2 has a straight first partial surface 23 on which the pretensioning element 3 abuts or on which it is supported, and a slanted second partial surface 24.

In the embodiment of the sealing arrangement 1 shown in FIG. 8, the sealing ring 2 abuts both groove flanks 51 and 52, wherein the rear side flank 26 on the high-pressure side has an extension in which the additional groove 27 is provided.

Further embodiments of the invention are feasible, which comprise one or several pretensioning element(s) in box-shaped stepped installation spaces, such as groove spaces, between machine parts, which can be moved in a translatory fashion with respect to each other, such as a piston rod or a piston and a cylinder. It is moreover also feasible to provide the full length or at least a partial length of the relief bore or the relief channel in the machine part that comprises the groove space, in particular, in the groove flanks and the groove bottom.

In a sealing arrangement 1 for sealing a high-pressure side H with respect to a low-pressure side N, comprising at least one relief bore or a relief channel 6 for pressure relief, a sealing ring 2 and at least one pretensioning element 3 are disposed in a groove space 5 between two machine parts 4a, 4b which can be moved in a translatory fashion with respect to each other, such that the pretensioning element 3 tensions the sealing ring 2 both with a radial force component 210 and with an axial force component 220, and the sealing ring 2 abuts the second machine part 4b and the groove flank 51 on the low-pressure side via defined contact surfaces 20, 22.

1-7. (canceled)

8. A machine component system for sealing a low pressure side of the system from a high pressure side of the system, the system comprising:
a first machine part;
a second machine part disposed for translatory motion relative to said first machine part, said second machine part defining a groove, said groove having a groove bottom, a first groove flank proximate said low pressure side, and a second groove flank proximate said high pressure side;
at least one rubber-elastic pretensioning element disposed within said groove and cooperating with said groove bottom; and
a sealing ring disposed within said groove between said pretensioning element and said first machine part, said pretensioning element and said sealing ring forming a sealing arrangement for sealing the high pressure side with respect to the low pressure side, said sealing ring defining at least one relief bore or relief channel having a first opening facing the low pressure side in a pressurized state of said sealing arrangement and having at least one second opening facing the high pressure side, wherein, in said pressurized state, said at least one first opening is closed by said first groove flank or by said at least one pretensioning element or said at least one first opening is limited by said first groove flank, said groove bottom and said pretensioning element, wherein, in an installed pressure-free state, said sealing ring abuts said first groove flank with an axially directed force component to press said sealing ring against said first groove flank thereby blocking connection between the low pressure side and said first opening, wherein said relief bore or relief channel is only opened in a pressure relief position in which a connection between the low pressure side and said first opening occurs in response to a force which opposes said axially directed force component.

9. The system of claim 8, wherein an outer surface of said sealing ring facing said groove bottom has at least one partial surface oriented at an inclination with respect to said groove bottom.

10. The system of claim 9, wherein said pretensioning element abuts said outer surface and cooperates with at least one side flank of said sealing ring which is disposed proximate the high pressure side.

11. The system of claim 8, wherein said at least one pretensioning element comprises a first pretensioning element and a second pretensioning element.

12. The system of claim 8, wherein, in an installed state, said sealing ring abuts said first groove flank and said second groove flank.

13. The system of claim 8, wherein said sealing ring has an additional sealing edge disposed proximate the low pressure side.

14. The system of claim 8, wherein one of said first and said second machine parts is a cylinder and another one of said first and said second machine parts is a piston rod of a piston guided in said cylinder.
